(19) United States
(12) Patent Application Publication
(10) Pub. No.: US 2006/0187657 A1
(43) Pub. Date: Aug. 24, 2006

(54) SELF-SUSTAINING ILLUMINATIVE APPARATUS

(76) Inventor: Sheng-Ghih Lin, Hsiu Shui Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/906,470

(22) Filed: Feb. 22, 2005

(51) Int. Cl. F21L 13/00; F21V 33/00

(52) U.S. Cl. 362/192; 362/234

(57) ABSTRACT

A self-sustaining illuminative apparatus includes a drum, an oscillation device installed in the drum for oscillation when subject to an external force, an induction device installed in the drum for generating electricity through induction in response to the oscillation of the oscillation device, and at least one light for illuminating with the electricity generated by means of the induction device.

### BACKGROUND OF INVENTION

1. Field of Invention

The present invention relates to a self-sustaining illuminative apparatus.

2. Related Prior Art

Conventionally, coils springs have been used to store energy for driving clocks and watches. However, the coil springs can only store a little energy and therefore have never been used to drive lights.

Conventionally, lights are powered by means of batteries. However, the lights brown out when the batteries run out of electricity.

The present invention is therefore intended to obviate or at least alleviate the problems encountered in prior art.

### SUMMARY OF INVENTION

A self-sustaining illuminative apparatus includes a drum, an oscillation device installed in the drum for oscillation when subject to an external force, an induction device installed in the drum for generating electricity through induction in response to the oscillation of the oscillation device, and at least one light for illuminating with the electricity generated by means of the induction device.

The primary advantage of the self-sustaining illuminative apparatus is that it lasts for a long time. Another advantage is its miniature size. Another advantage is that when used as a warning apparatus attached to a wheel, it provides a more obvious warning effect when the speed of the when goes up.

Other advantages and novel features of the invention will become more apparent from the following detailed description when taken in conjunction with the drawings.

### BRIEF DESCRIPTION OF DRAWINGS

The present invention will be described through detailed illustration of the preferred embodiment referring to the drawings.

FIG. 1 is a perspective view of a self-sustaining illuminative apparatus according to the preferred embodiment of the present invention.

FIG. 2 is an explode view of the self-sustaining illuminative apparatus shown in FIG. 1.

FIG. 3 is a front view of a wheel equipped with the self-sustaining illuminative apparatus of FIG. 1.

FIG. 4 is a cross-sectional view of the self-sustaining illuminative apparatus of FIG. 1 and shows a magnet oscillated to and fro in the drum when the wheel rolls.

FIG. 5 shows a plurality of lights of the self-sustaining illuminative apparatus shown in FIG. 1 shining.

### DETAILED DESCRIPTION OF PREFERRED EMBODIMENT

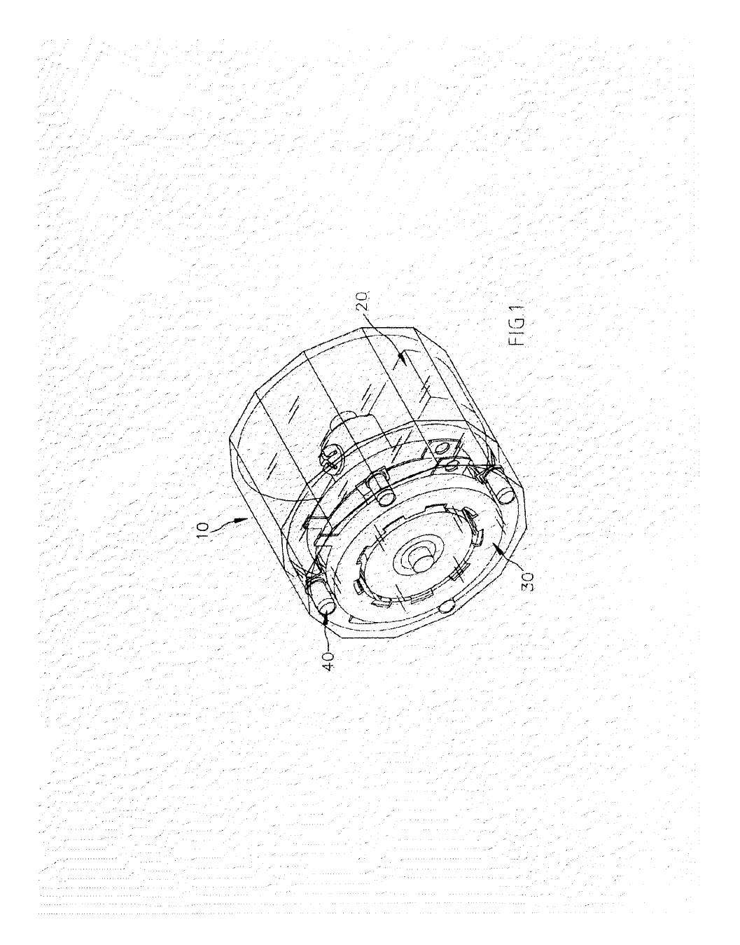

FIG. 1 shows a self-sustaining illuminative apparatus according to the preferred embodiment of the present invention.

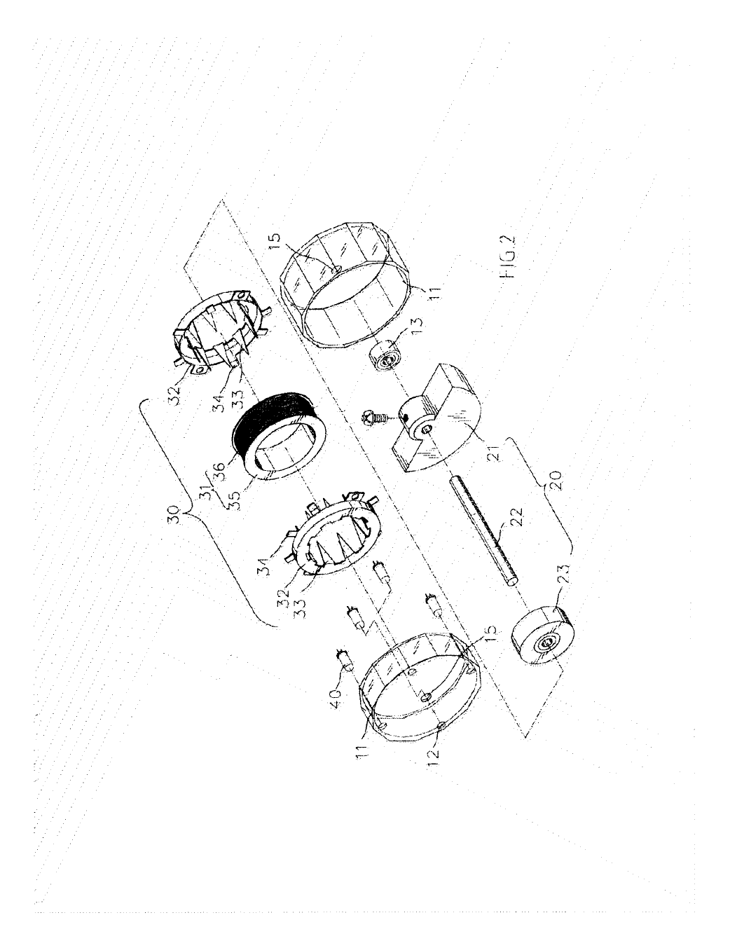

Referring to FIG. 2, the self-sustaining illuminative apparatus includes a drum 10, an oscillation device 20, an induction device 30 and a plurality of lights 40.

The drum 10 consists of two shells 11. Each of the shells 111 includes a central aperture 15 defined therein. One of the shells 11 includes a plurality of apertures 12 defined therein around the central aperture 15.

The oscillation device 20 is installed in the drum 10. The oscillation device 20 includes a pendulum 21 and a spindle 22. The pendulum 21 is installed on the spindle 22. The spindle 22 includes two ends each fit in the central aperture 15 of a related shell 11. A bearing 13 is provided between the pendulum 21 and the spindle 22.

The induction device 30 includes a magnet 23, an induction coil set 31 and two conductive elements 32. The magnet 23 is attached to pendulum 21 so that the magnet 23 can swing with the pendulum 21 synchronously. The induction coil set 31 includes a reel 35 provided around the magnet 23 and an induction coil 36 wound on the reel 35.

Each conductive element 32 is an annular element with a plurality of strips 33 formed along an internal edge and a plurality of contacts 34 formed along an external edge. Each conductive element 32 is connected with an end of the coil 36. The strips 33 of the conductive elements 32 extend in the reel 35 so that the strips 33 of a conductive element 32 are arranged in an alternate manner with the strips 33 of the other conductive element 32. Each strip 33 is triangular. Thus, the strips 33 of conductive elements 32 are useful for generating a stable electric current even when the oscillation is small and unstable.

Each of the lights 40 includes two leads 41. A lead 41 of each light 40 is connected with corresponding one of the contacts 34 of a conductive element 32 while the other lead 41 of the light 40 is connected with corresponding one of the contacts 34 of the other conductive element 32.

The light 40 may be a light-emitting diode (“LED”) or a tungsten lamp. Each LED or tungsten lamp is aligned with the aperture 12 so that light emitted from each LED or tungsten lamp passes through a corresponding aperture 12.

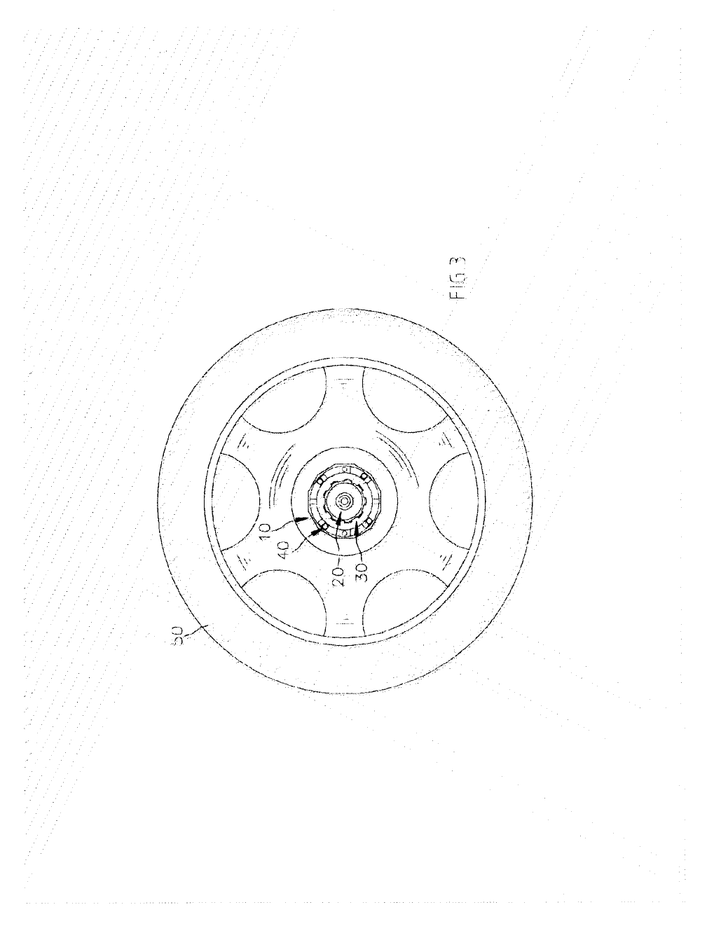

FIG. 3 shows the self-sustaining illuminative apparatus installed on a wheel 50. The self-sustaining illuminative apparatus can be installed on the wheel 50 by means of gluing, welding or screwing.

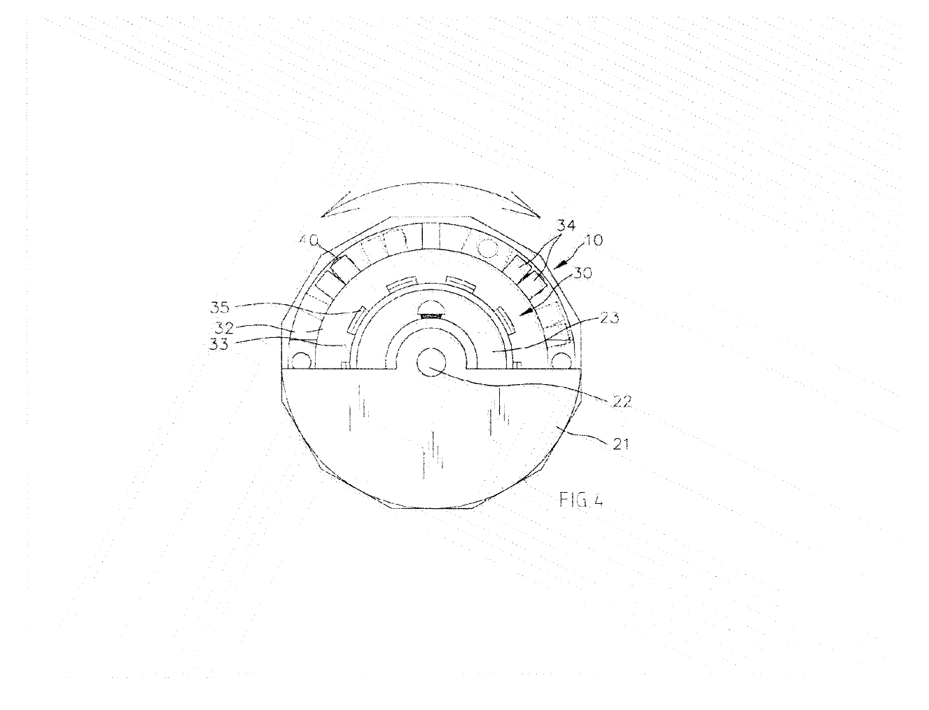

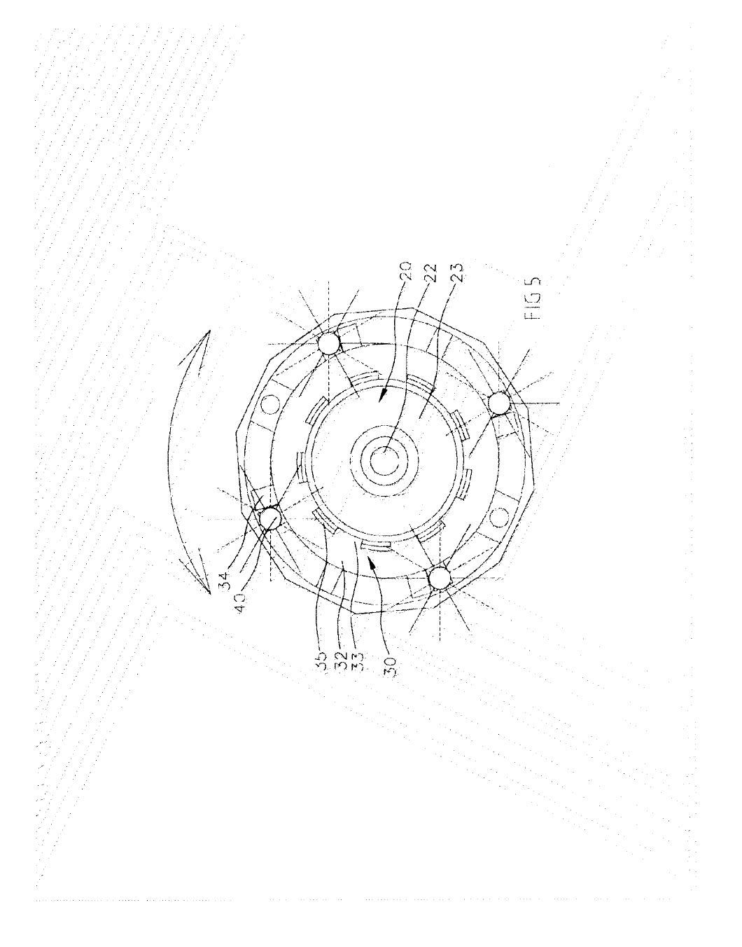

FIGS. 4 and 5 show the self-sustaining illuminative apparatus rotated with the wheel 50 synchronously. The magnet 23 is oscillated to and fro in the induction coil set 31 by means of the pendulum 21. Thus, electricity is generated and conducted to the first and second conductive elements 32. Therefore, the lights 40 receive the electricity from the conductive elements 32 for illumination.

The present invention has been described through detailed illustration of the preferred embodiment. Those skilled in the art can derive variation from the preferred embodiment without departing from the scope of the present invention. Therefore, the preferred embodiment shall not limit the scope of the present invention defined in the claims.

What is claimed is:

1. A self-sustaining illuminative apparatus comprising a drum, an oscillation device installed in the drum for oscillation when subject to an external force, an induction device installed in the drum for generating electricity through induction in response to the oscillation of the oscillation device, and at least one light for illuminating with the electricity generated by means of the induction device.

2. The self-sustaining illuminative apparatus according to claim 1 wherein the oscillation device comprises a pendulum installed in the drum.

3. The self-sustaining illuminative apparatus according to claim 2 wherein the oscillation device comprises a spindle for supporting the pendulum in the drum.

4. The self-sustaining illuminative apparatus according to claim 3 wherein the oscillation device comprises a bearing installed between the pendulum and the spindle.

5. The self-sustaining illuminative apparatus according to claim 2 wherein the induction device comprises a magnet attached to the pendulum and a coil installed around the magnet.

6. The self-sustaining illuminative apparatus according to claim 5 wherein the induction device comprises two conductive elements each connected with an end of the coil, wherein the light comprises two leads each connected with related one of the conductive elements.

7. The self-sustaining illuminative apparatus according to claim 6 wherein each of the conductive element comprises a plurality of strips extending in the coil so that they are arranged in an alternate manner with the strips of the other conductive element.

8. The self-sustaining illuminative apparatus according to claim 7 wherein each of the strips includes a triangular configuration.

9. The self-sustaining illuminative apparatus according to claim 5 wherein the induction device comprises a reel for carrying the coil.

10. The self-sustaining illuminative apparatus according to claim 5 wherein each of the conductive elements comprises at least one contact for contact with one of the leads of the light.

11. The self-sustaining illuminative apparatus according to claim 1 wherein the light is a light-emitting diode.

12. The self-sustaining illuminative apparatus according to claim 1 wherein the light is a tungsten lamp.

13. The self-sustaining illuminative apparatus according to claim 1 wherein the drum consists of two shells.
